(19) United States
(12) Patent Application Publication
(10) Pub. No.: US 2014/0245454 A1
(43) Pub. Date: Aug. 28, 2014

(54) METHOD AND APPARATUS FOR PROTECTING FLIGHT DATA

(71) Applicants: Inha Industry Partnership Institute, Incheon (KR); Electronics And Telecommuncations Research Institute, Daejeon (KR)

(72) Inventors: Deok Gyu LEE, Daejeon (KR); Seoung Hyeon LEE, Daejeon (KR); Byeong Cheol CHOI, Daejeon (KR); Yong Kyun KIM, Daejeon (KR); Jong-Wook HAN, Daejeon (KR); Hyo Dal PARK, Incheon (KR)

(21) Appl. No.: 13/933,875

(22) Filed: Jul. 2, 2013

(30) Foreign Application Priority Data
Feb. 28, 2013 (KR) 10-2013-0022113

(51) Int. Cl. G06F 21/60; G06F 11/08

(52) U.S. Cl. CPC G06F 21/60; G06F 11/08
USPC 726/26

(57) ABSTRACT

The present invention relates to a system and method for automatically protecting flight data in response to a variety of kinds of cyber terror that paralyze control service in a flight data system by enhancing the availability, reliability, and integrity of the flight data system when damage due to external or internal viruses or hacking, such as the alteration or modification of flight data, occurs. The flight data protection system has an advantage in that it can manage a system safely by providing an embedded system, using an Enhanced Write Filter (EWF), and protecting an Operating System (OS).

### RELATED APPLICATION(S)

This application claims the benefit of Korean Patent Application No. 10-2013-0022113, filed on Feb. 28, 2013, which is hereby incorporated by references as if fully set forth herein.

### FIELD OF THE INVENTION

The present invention relates to flight data protection technology and, more particularly, to a flight data protecting apparatus and method for detecting the forgery and alternation of flight data and automatically providing disaster recovery in response to a variety of kinds of cyber terror that interfere with the operation of a flight data processing system by increasing the availability, reliability, and integrity of a system in providing control service, such as the transmission of the flight data internally or externally.

### BACKGROUND OF THE INVENTION

The amount of data processed by a flight data processing system, which is the essence of flight control, is huge because a multitude of countries and a variety of kinds of flight data related to the flight data processing system have to be handled. Furthermore, the flight data processing system is used by a number of specific persons, whereby external and internal attacks against the flight data processing system are diverse and increasingly sophisticated, thereby increasing the threat to an application layer, that is, the entire data processing system.

In particular, although defense is provided at the network layer using a firewall, a Secure Socket Layer (SSL), an Intrusion Detection System (IDS)/Intrusion Prevention System (IPS), a Virtual Private Network (VPN), and a secure Operating System (OS), which are existing systems, the flight data processing system is vulnerable to the forgery and alteration of flight data by an internal attacker. Furthermore, even in the security of this network layer, threats to the application layer still remain.

Such threats can result in extensive damage, such as the interruption of control service, harm to humans attributable to a flight accident, the loss of public confidence and national reputation, and economic loss resulting from damage recovery, due to the paralysis of the entre flight data processing system.

In the prior art, the flight data processing system cannot be protected against a variety of kinds of cyber terror, such as hacking, or from internal attackers, due to the weak system. Furthermore, not all countries have the same security level, even though the flight network is currently a closed network, and thus the flight data processing system is vulnerable to internal attackers and external hacking, even though all countries have the same security level.

### SUMMARY OF THE INVENTION

An embodiment of the present invention provides flight data protection technology in which a flight data processing system installed in a network can monitor a variety of kinds of hacking and cyber terror in real time, and can provide seamless control service by automatically recovering from a disaster when the flight data processing system is forged or modified.

In accordance with an aspect of the present invention, there is provided an apparatus for protecting flight data, including a flight data verification module for classifying original flight data for each field and verifying the classified data in order to protect the flight data against an external attack, a flight data database for storing the verified flight data for each field, a flight data monitoring module for hooking messages for the original flight data input to and output from the flight data verification module and monitoring the hooked messages, a host message monitoring module for generating flight data for recovery in response to a monitoring result message provided by the flight data monitoring module, and a flight data restoration management module for restoring the original flight data by using the generated flight data for recovery.

### BRIEF DESCRIPTION OF THE DRAWINGS

The objects and features of the present invention will become apparent from the following description of embodiments given in conjunction with the accompanying drawings, in which:

FIG. 1 is a block diagram of a flight data protection system including an apparatus for protecting flight data in accordance with an embodiment of the present invention;

FIG. 2 is a flowchart illustrating a flight data protection process in accordance with an embodiment of the present invention;

FIG. 3 is a flowchart illustrating the process of implementing automatic real-time disaster recovery by obtaining a flight data dictionary in a method for protecting flight data in accordance with an embodiment of the present;

FIG. 4 is a flowchart illustrating the process of generating a flight data dictionary and keeping the original flight data in the method for protecting flight data in accordance with an embodiment of the present invention;

FIG. 5 is a flowchart illustrating the processing performed by a flight data monitoring module 112 in the method for protecting flight data in accordance with an embodiment of the present invention; and

FIG. 6 is a flowchart illustrating the process of restoring flight data in the method for protecting flight data in accordance with an embodiment of the present invention.

### DETAILED DESCRIPTION OF THE EMBODIMENTS

Hereinafter, embodiments of the present invention will be described in detail with reference to the accompanying drawings which form a part hereof.

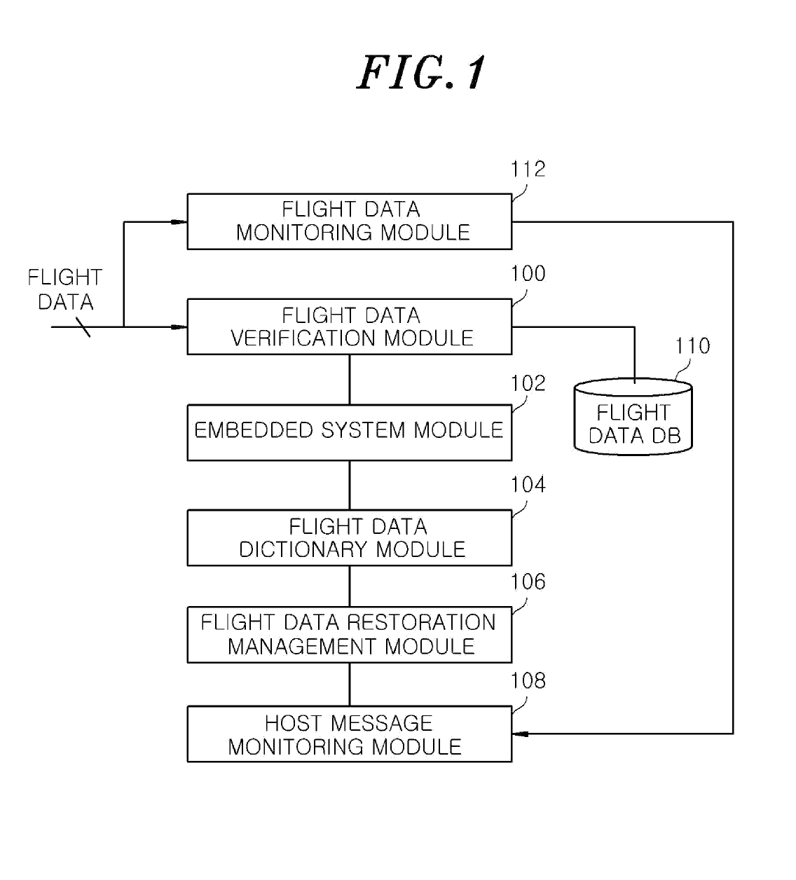

FIG. 1 is a block diagram of a flight data protection system including an apparatus for protecting flight data in accordance with an embodiment of the present invention. The flight data protection system can include a flight data verification module 100, an embedded system module 102, a flight data dictionary module 104, a flight data restoration management module 106, a host message monitoring module 108, a flight data database (DB) 110, and a flight data monitoring module 112.

The flight data verification module 100 can function to classify the original flight data into fields and verify the classified flight data in order to protect the original flight data against malicious attacks. For example, the flight data verification module 100 can divide received flight data into data that must be secured and data that do not need to be secured, subdivide the data that must be secured for each field, and verify the subdivided data. The flight data verified by the flight data verification module 100 can be classified into fields and stored in the flight data DB 110.

The embedded system module 102 stores a proper embedded system so that the flight data can be classified into fields and combined by the flight data verification module 100.

The flight data dictionary module 104 can store the original flight data and reproduce the stored original flight data.

The flight data restoration management module 106 can function to restore the original flight data depending on the situation, and can store an event log.

The host message monitoring module 108 can provide the flight data restoration management module 106 with flight data for recovery in response to a monitoring result message provided by the flight data monitoring module 112. The host message monitoring module 108 can become a mediator for the transmission of the flight data for recovery depending on the situation, and for connection with the flight data monitoring module 112.

The flight data DB 110 can store the flight data, which has been classified into fields and provided by the flight data verification module 100.

The flight data monitoring module 112 can monitor the original flight data using a filter driver. For example, the flight data monitoring module 112 can hook pieces of input/output request information delivered to a file system driver or a disk driver and supplement functions provided by an existing driver or add a new function to the functions using the hooked information. The flight data monitoring module 112 can exist in a daemon form and monitor whether flight data is abnormal or not.

The flight data protection apparatus sends a monitoring result message over an external network and becomes a mediator for the transmission of flight data for recovery depending on the situation and for connection with the daemon and agent of the system (alternatively called a host).

From among the elements of the flight data protection apparatus, the embedded system module 102, the flight data DB 110, an OS depository module (not shown), and the flight data dictionary module 104 protect the system by means of write prevention using an Enhanced Write Filter (EWF), thereby being capable of increasing the availability, reliability, and integrity of the system.

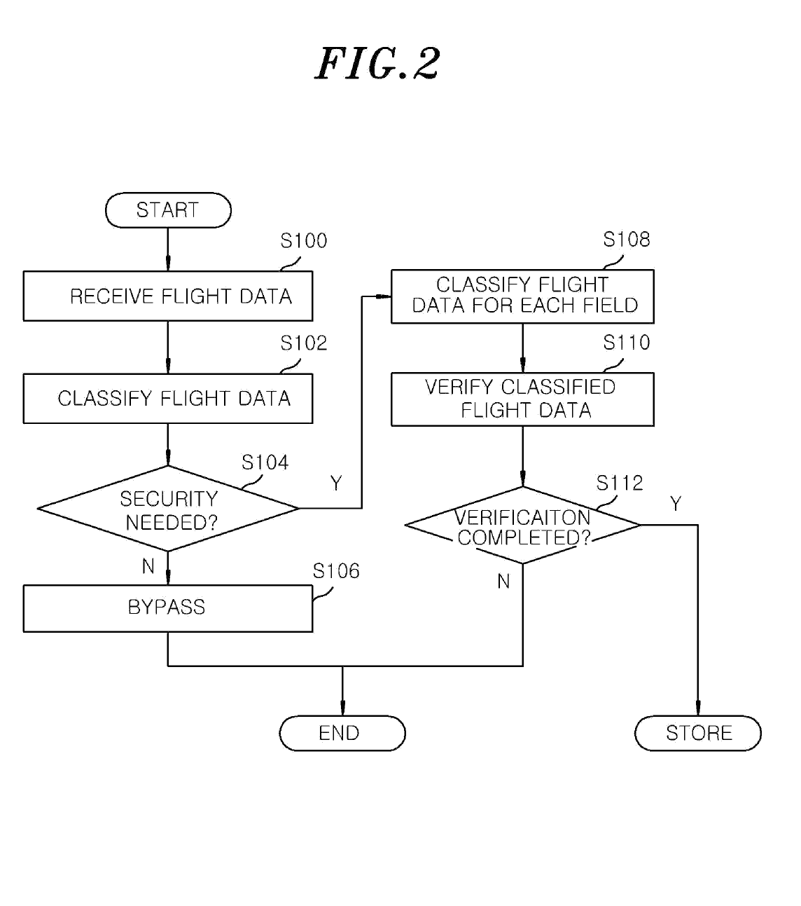

A method for protecting flight data in accordance with an embodiment of the present invention is described in detail below with reference to the aforementioned elements and FIGS. 2 to 6.

First, FIG. 2 is a flowchart illustrating a flight data protection process in accordance with an embodiment of the present invention.

This process can be performed when flight data is input to the flight data verification module 100. All flight messages are subject to a classification task depending on their histories. The classification task is performed on verified data, and the classified data is used when the data is analyzed and an accident occurs.

As shown in FIG. 2, when the flight data is received at step S100, the flight data can be classified for each category at step S102 and divided into data that must be secured and data that does not need to be secured at step S104. Here, the data that does not need to be secured can be bypassed, that is, processed externally, at step S106.

A separation task for classifying the data that must be secured into detailed fields can be performed at step S108.

A verification process can be performed on the separated detailed fields at step S110. The verification process can include, for example, priority verification, aircraft ID verification, wake turbulence verification, departure airport verification, flight route verification, and destination airport verification.

After all the fields are verified, the fields can be stored at step S112.

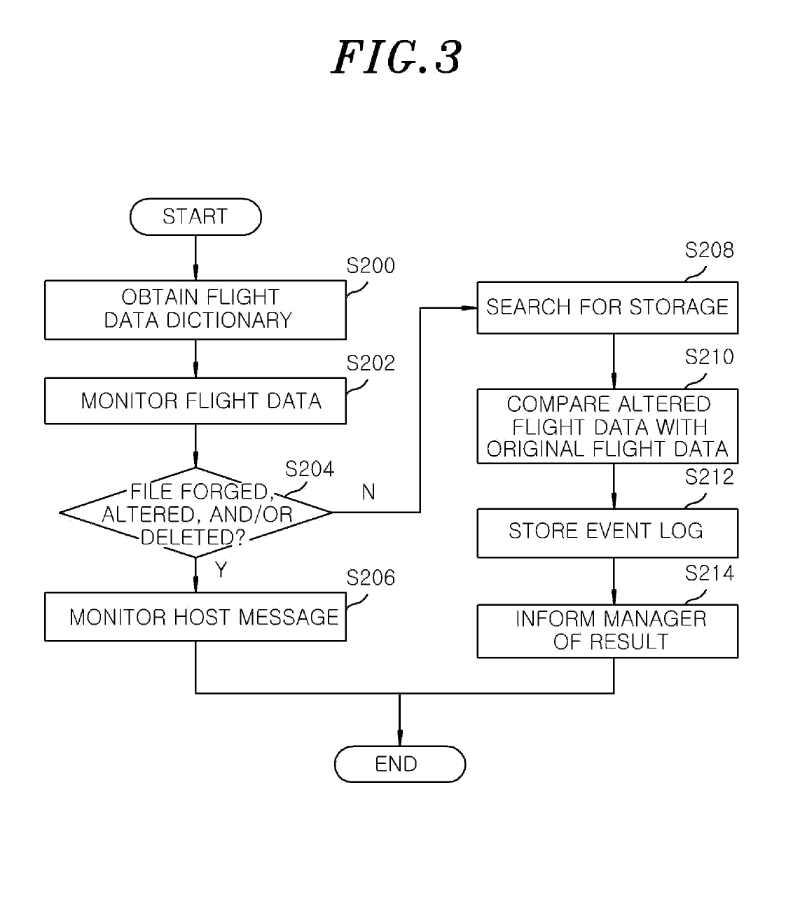

FIG. 3 is a flowchart illustrating the process of implementing automatic real-time disaster recovery by obtaining a flight data dictionary in a method for protecting flight data in accordance with an embodiment of the present.

As shown in FIG. 3, in the method for protecting flight data, first, a flight data dictionary is obtained from a host at step S200. The host message monitoring module 108 of the host monitors flight data at step S202. As a result of hooking the flight data when a system event occurs, if the flight data has been deleted, forged, and/or altered at step S204, or if new flight data has been generated in the system, the flight data is transferred to the host message monitoring module 108 at steps S206 and S208. The restoration module is driven at step S210, the flight data is processed depending on the situation, an event log is stored at step S212, and a restoration manager can be informed of the processing situation at step S214. Here, the restoration manager can be informed of the processing situation via e-mail or SMS.

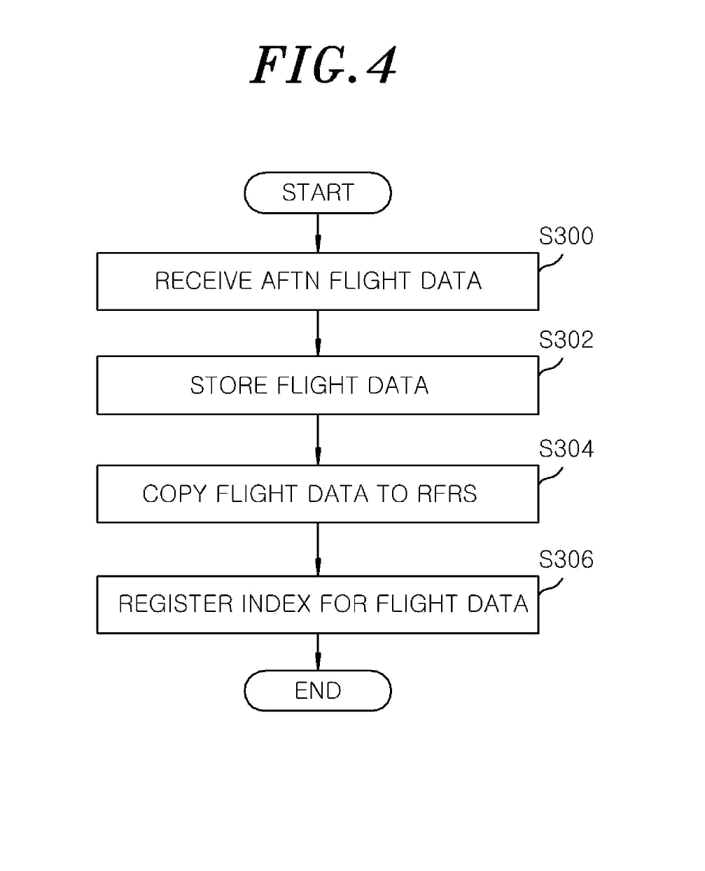

FIG. 4 is a flowchart illustrating the process of generating a flight data dictionary and keeping the original flight data in the method for protecting flight data in accordance with an embodiment of the present invention.

As shown in FIG. 4, this process of generating a flight data dictionary serves to keep the original flight data.

Flight data is received over an Aeronautical Fixed Telecommunication Network (AFTN) at step S300, and is then stored at step S302.

Here, a manager only has permission to store the flight data, and the stored flight data can be reproduced or copied to the flight data DB 110 of the flight data protection apparatus at steps S304 and S306.

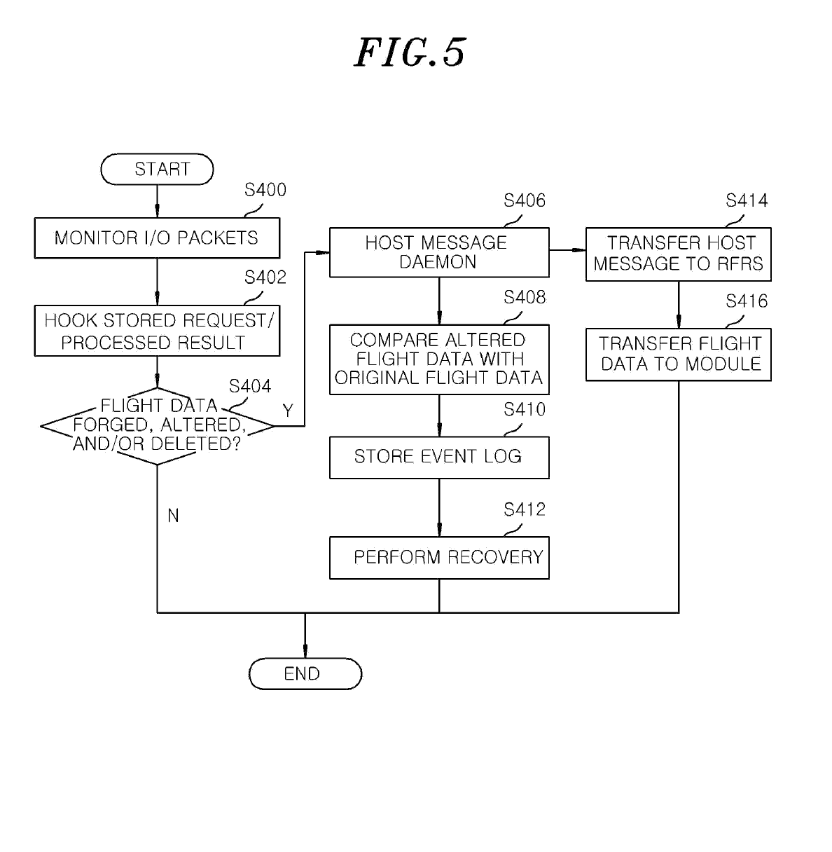

FIG. 5 is a flowchart illustrating the processing performed by the flight data monitoring module 112 in the method for protecting flight data in accordance with an embodiment of the present invention.

As shown in FIG. 5, the flight data monitoring module 112 monitors I/O request packets at step S400.

The flight data monitoring module 112 basically uses a filter driver. The filter driver can hook I/O requests transferred to a driver, such as a file system driver or a disk driver at step S400, and can either supplement functions provided by an existing driver or add a new function to the functions.

When a request for flight data is transmitted, or when processed flight data is transmitted in response to a request for the processed flight data, the flight data monitoring module 112 can hook the request and the processed flight data in order to check whether or not the request and the processed flight data are a legitimate request and a legitimate processing result at step S402.

The flight data monitoring module 112 checks whether or not the flight data has been forged, altered, or deleted as a result of the hooking at step S404. If, as a result of the check, the flight data has been forged, altered, or deleted, the flight data monitoring module 112 sends a system message (i.e., a monitoring result message) to the host message monitoring module 108 at step S406 so that the host message monitoring module 108 can make an appropriate response depending on the situation.

Here, the executed process complies with the following procedure.

The host message monitoring module 108 can reside in a daemon form in the flight data protection apparatus, analyze messages received from the host and the agent of the flight data processing apparatus at step S414, and take a suitable response for each situation.

Next, the flight data dictionary module 104 can compare the forged or altered flight data with the original flight data at step S408. If, as a result of the comparison, the forged or altered flight data is not identical with the original flight data, a recovery type depending on the situation can be determined and recovery can be performed at step S412.

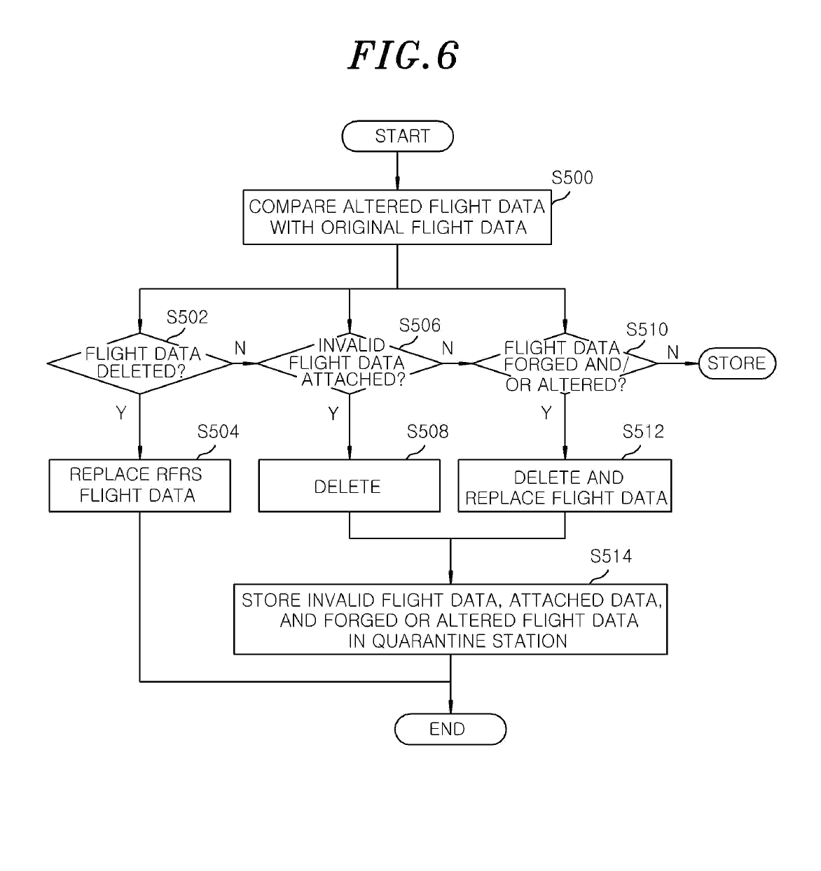

FIG. 6 is a flowchart illustrating a process of restoring flight data in the method for protecting flight data in accordance with an embodiment of the present invention.

The process of FIG. 6 is performed by the flight data restoration management module 106. If an abnormality is present in the flight data, the flight data restoration management module 106 can compare the abnormal flight data with the original flight data stored in a flight data dictionary at step S500.

If flight data has been deleted at step S502, the flight data restoration management module 106 searches the flight data DB 110 for the original flight data corresponding to the deleted flight data and restores the system to a point in time prior to the point in time at which the flight data was deleted. If invalid flight data has been added, the flight data restoration management module 106 can delete the invalid flight data at step S504.

If the flight data has been modified or altered at step S506, the flight data restoration management module 106 can restore the system by deleting the modified or altered flight data and sending the original flight data at step S508.

If the flight data has been forged or altered at step S510, the flight data restoration management module 106 can respond to each situation (e.g., normal behavior or abnormal behavior) at step S512, and can store corresponding flight data in a quarantine station so that future problems having the same pattern can be processed at step S514.

In accordance with the embodiments of the present invention, the flight data processing system installed in a network monitors various kinds of hacking and cyber terror in real time and automatically restores modified or altered flight data if the flight data has been modified or altered. Accordingly, seamless control service can be provided.

In accordance with the present invention, the availability of a flight data processing system against cyber terror or malicious changes occurring in the flight data processing system can be maximized, and control service can be stably provided while the operation of the flight data processing system is stopped. Furthermore, flight data can be processed and restored in relation to various kinds of attacks (e.g. cyber terror, attacks by internal attackers, the forgery/alteration of a file), and the same type of attack can be prevented by analyzing an event log. Furthermore, forged flight data is not manually restored, and is not suddenly restored to an initial state, but is automatically restored in real time. Accordingly, there is an advantage in terms of recovery cost, and the loss of public confidence and harm to humans can be prevented.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for protecting flight data, comprising:
a flight data verification module for classifying original flight data for each field and verifying the classified data in order to protect the flight data against an external attack;
a flight data database for storing the verified flight data for each field;
a flight data monitoring module for hooking messages for the original flight data input to and output from the flight data verification module and monitoring the hooked messages;
a host message monitoring module for generating flight data for recovery in response to a monitoring result message provided by the flight data monitoring module; and
a flight data restoration management module for restoring the original flight data by using the generated flight data for recovery.

2. The apparatus of claim 1, wherein the flight data verification module classifies the original flight data into data requiring security and data not requiring security.

3. The apparatus of claim 2, wherein the flight data verification module verifies the data requiring security for each field.

4. The apparatus of claim 3, wherein the flight data verification module performs at least one of priority verification, aircraft ID verification, wake turbulence verification, departure airport verification, flight route verification, and destination airport verification for each field.

5. The apparatus of claim 1, wherein the flight data monitoring module monitors the original flight data using a filter driver.

6. The apparatus of claim 5, wherein the filter driver hooks input request information or output request information transferred to a file system driver or a disk driver.

7. The apparatus of claim 1, wherein the flight data verification module classifies and verifies the original flight data for each field using an embedded system.

8. A method for protecting flight data, comprising:
by a flight data verification module, classifying original flight data for each field;
by the flight data verification module, performing at least one of priority verification, aircraft ID verification, wake turbulence verification, departure airport verification, flight route verification, and destination airport verification on the classified flight data; and
storing the verified flight data for each field.

9. The method of claim 8, wherein the classifying, by the flight data verification module, original flight data for each field comprises classifying the original flight data into data requiring security and data not requiring security.

10. The method of claim 8, wherein the performing at least one of priority verification, aircraft ID verification, wake turbulence verification, departure airport verification, flight route verification, and destination airport verification comprises verifying the original flight data for each field using an embedded system.

11. A method for protecting flight data, comprising:
by a flight data monitoring module, hooking messages for original flight data input to or output from a flight data verification module and monitoring the hooked messages;
by a host message monitoring module, generating original flight data for recovery in response to a result of the monitoring; and
by a flight data restoration management module, restoring the original flight data using the generated flight data.
